(19) United States
(12) Patent Application Publication
(10) Pub. No.: US 2015/0125586 A1
(43) Pub. Date: May 7, 2015

(54) BEVERAGE SYSTEM WITH FLAVOR POD DISPENSER

(71) Applicant: Erdogan Ergican, Torrance, CA (US)

(72) Inventor: Erdogan Ergican, Torrance, CA (US)

(73) Assignee: APIQE, Torrance, CA (US)

(21) Appl. No.: 14/396,013

(22) PCT Filed: Apr. 25, 2013
(86) PCT No.: PCT/US2013/038226

§ 371 Date: Oct. 21, 2014

Related U.S. Application Data
(60) Provisional application No. 61/713,980, filed on Oct. 15, 2012.
(60) Provisional application No. 61/714,068, filed on Oct. 15, 2012.
(60) Provisional application No. 61/638,324, filed on Apr. 25, 2012.
(60) Provisional application No. 61/638,337, filed on Apr. 25, 2012.
(60) Provisional application No. 61/638,346, filed on Apr. 25, 2012.

(51) Int. Cl. A47J 31/40; A47J 31/46

(52) U.S. Cl. CPC A47J 31/407; A47J 31/46
USPC 426/590; 99/295

(57) ABSTRACT

In one aspect, an apparatus is disclosed for mechanically dispensing flavor from a flavor pod, the apparatus including: a casing; a pod delivery and retaining unit, and a flavor extraction unit.

### CROSS-REFERENCE TO RELATED APPLICATIONS

The present application claims the benefit of U.S. Provisional Patent Application Ser. Nos. 61/638,324, 61/638,337, and 61/638,346, each filed Apr. 25, 2012 and of U.S. Provisional Patent Application Ser. Nos. 61/713,980 and 61/714,068 each filed Oct. 15, 2012. The disclosures of each of the foregoing are incorporated herein by reference in their entirety for all purposes.

The disclosures of each International Patent Applications Ser. Nos. PCT/US2012/043873, PCT/US2012/043797, and PCT/US2012/043708 each filed Jun. 22, 2012, are incorporated herein by reference in their entirety for all purposes.

The disclosure of U.S. patent application Ser. No. 12/772,641 filed May 3, 2010 entitled “APPARATUSES, SYSTEMS AND METHODS FOR EFFICIENT SOLUBILIZATION OF CARBON DIOXIDE IN WATER USING HIGH ENERGY IMPACT,” is incorporated herein by reference in its entirety for all purposes.

### BACKGROUND

Numerous types of water dispensers are available, including dispensers for chilled, unchilled (e.g., room temperature), and heated water. Some water dispensers dispense carbonated water. Water dispensers can include a reservoir or a pressurized source. Water dispensers may be stand alone devices, or incorporated into an appliance such as a refrigerator.

Most commercialized devices for carbonating water use carbon dioxide sprayed into a water container: the result obtained with this process is very poor and the carbonation of water is weak and does not last too long. Devices for producing and dispensing carbonated beverages in water dispensing units, instead, typically employ a carbonating tank, called a saturator, and a high-pressure water pump. Carbonated water is produced by pressurizing the saturator tank with carbon dioxide and filling the tank with chilled water. Due to the high pressures resident in the saturator tank, typically around 70 psi, a relatively expensive high pressure water pump is required to inject water into the tank. Furthermore, under the conditions in the saturator tank, the carbon dioxide takes time to dissolve into to the water and achieve a palatable level of carbonization. Accordingly, the saturator is typically large enough to hold a ready supply of carbonated water for dispensing and does not create new carbonated water instantaneously on demand. To maintain this supply, two or more sensors—and associated electronic controls—are used to start the high pressure pump and inject water into saturator when the level of carbonated water in the saturator falls below a set threshold and then stop the water injection when the tank fills to an appropriate level.

These typical carbonization devices take up a relatively large amount of space and require expensive and complicated electronic and hydraulic control systems. Due to this complex structure, these devices are noisy, use significant amounts of energy, and require frequent maintenance.

### SUMMARY

In one aspect, an apparatus is disclosed for mechanically dispensing flavor from a flavor pod, the apparatus including: a casing; a pod delivery and retaining unit, and a flavor extraction unit.

In some embodiments, the pod delivery and retaining unit is configured position and retain a pod inserted in the apparatus, and dislodge spent pods following flavor extraction.

In some embodiments, the pod delivery and retaining unit to is configured to: deliver the pod to the flavor extraction unit, coordinate with the extraction system to extract flavor and mixing, and serve as a mechanical locking mechanism against back pressure created by the injection fluid into the pod.

In some embodiments, the apparatus is lever actuated.

In some embodiments, the flavor extraction unit selectively serves as a water shut-off.

In some embodiments, the flavor extraction unit is configured to create incisions in the pod to extract the flavor.

In some embodiments, the casing include a top cover, a housing; and tensioning element. In some embodiments, the housing retains the top cover while allowing the top cover to slidably open to expose the interior of the housing; and the tensioning element provides a force tending to slide the top cover towards an open position.

Some embodiments include a lever mechanism configured to actuate the top cover between the open position and a closed position.

Some embodiments include at least one sensor configured to detect the open or closed state of the top cover.

In some embodiments, the pod delivery and retaining unit includes: a lever configured to allows the opening and closing of the top cover, and lock down of the flavor extraction unit during extraction.

Some embodiments include a pod holder actuated by movement of the lever.

Some embodiments include one or more swivel arms configured to convert rotational motion of the lever into lateral motion of the pod holder.

Some embodiments are configured such that the pod holder is pushed towards the flavor extracting system when the lever is pushed down to load a new flavor pod, the pod holder is pulled away from away from the flavor extracting system when the lever is pulled up to dislodge pod.

Some embodiments include one or more pod catching elements configured to receive a pod inserted through the housing and transfer the pod to the pod holder in response to actuation of the lever.

In some embodiments, in response to actuation of the lever: the pod holder travels towards and receives a flavor pod: the pod holder laterally displaces the catching element to release the pod into the pod holder.

In some embodiments, the catching element includes a spring element having an equilibrium position, and the pod holder is configured to displace the catching element away from the equilibrium position.

In some embodiments, during an unloading actuation of the lever, the catching elements are configured to facilitate disposal of a pod from the apparatus.

In some embodiments, the flavor extraction system includes: a seal plate, and a seal housing opposing the seal plate. In some embodiments where the seal housing and seal plate are configured to, in response to actuation of the lever: receive the pod; pierce the pod: and establish a sealed fluid flow path through the pod to promote mixing of flavor material in the pod with fluid flowing through the path.

Some embodiments include a flow splitting mechanism configured to: divert a portion of the flow from a fluid line to the flavor pod; and return a resulting flavored water stream from the pod to be mixed with a main stream of the water line.

In another aspect, a method is disclosed including dispensing flavor using the apparatus of any of the types described above.

In another aspect, a system for dispensing flavored water is disclosed including: a main inlet configured to receive water from a source; a filter for filtering water from the source; a flavor dispenser including the apparatus of any of the types described above; and a controller configured to control the flow of fluid through the system to selectively dispense flavored and unflavored water.

Some embodiments include a chilled water line, including: an in-line carbonator; a carbonator water inlet valve configured to selectively direct water from the main inlet to the carbonator; a carbonator gas inlet valve configured to selectively direct carbonating gas to the carbonator; and a chilled water line outlet configured to direct chilled water to the flavor dispenser; a heat exchanger configured to chill water passing through the chilled water dispensing line; and a controller configured to control the carbonator water and gas inlet valves. In some embodiments when the carbonator water inlet valve is open and the carbonator water inlet valve is closed, the chilled water line dispenses still water at the chilled water line outlet; and when the carbonator water inlet valve is open and the carbonator water inlet valve is open, the chilled water line dispenses carbonated water at the chilled water line outlet.

Some embodiments include an unchilled water line including an unchilled water inlet valve configured to selectively direct water from the main inlet to an unchilled water line outlet, the outlet configured to direct chilled water to the flavor dispenser.

Some embodiments include: an unchilled water line including: an unchilled water inlet valve configured to selectively direct water from the main inlet through a heater to a heated water line outlet, the outlet configured to direct heated water to the flavor dispenser.

Various embodiments may include any of the above features or elements in any suitable combination.

### BRIEF DESCRIPTION OF THE DRAWINGS

FIG. 1 shows an illustration of a beverage dispenser assembled (left pane) and partially disassembled (right pane).

FIG. 2 shows front, side, back, top and bottom views of the beverage dispenser of FIG. 1.

FIG. 3 shows an exploded view of the beverage dispenser of FIG. 1.

FIG. 4 shows an exploded view of an alternate embodiment of the beverage dispenser of FIG. 1 featuring hot beverage dispensing.

FIG. 5 shows an exploded view of another alternate embodiment of the beverage dispenser of FIG. 1 featuring carbonated beverage dispensing.

FIG. 6 shows a functional block diagram of the beverage dispenser of FIG. 1.

FIG. 7 shows an illustration of a beverage dispenser assembled (left pane) and partially disassembled (right pane).

FIG. 8 shows front, side, back, top and bottom views of the beverage dispenser of FIG. 7.

FIG. 9 shows an exploded view of the beverage dispenser of FIG. 7.

FIG. 10 shows an exploded view of an alternate embodiment of the beverage dispenser of FIG. 1 featuring sparkling beverage dispensing.

FIG. 11 shows an exploded view of a flavor pod dispenser

FIG. 12 shows plan and side views of the flavor pod dispenser is a closed position (top row) and an open position (bottom row).

FIG. 13 illustrates the operation of the flavor pod dispenser of FIG. 11.

FIG. 14 illustrates a flavor mixing arrangement.

FIG. 15 illustrates the use of the flavor mixing arrangement of FIG. 14 used with the flavor pod dispenser of FIG. 11.

FIGS. 16A-L illustrate filter cartridge assemblies for use with a beverage dispenser system. FIGS. 16A-16E show views of a first embodiment. FIGS. 16F-16H show views of a second embodiment. FIGS. 16 I-16L show views of a third embodiment featuring a nested bracket arrangement.

### DETAILED DESCRIPTION

Various water dispensers in the market are available: dispensing chilled, unchilled, and hot water; and some also dispense carbonated water. It would be desirable to provide an all-in-one dispenser that is capable to dispense some or all of the aforementioned types of beverages in addition to juices, teas, coffees, and sodas through, e.g., a single-serve pod delivery system.

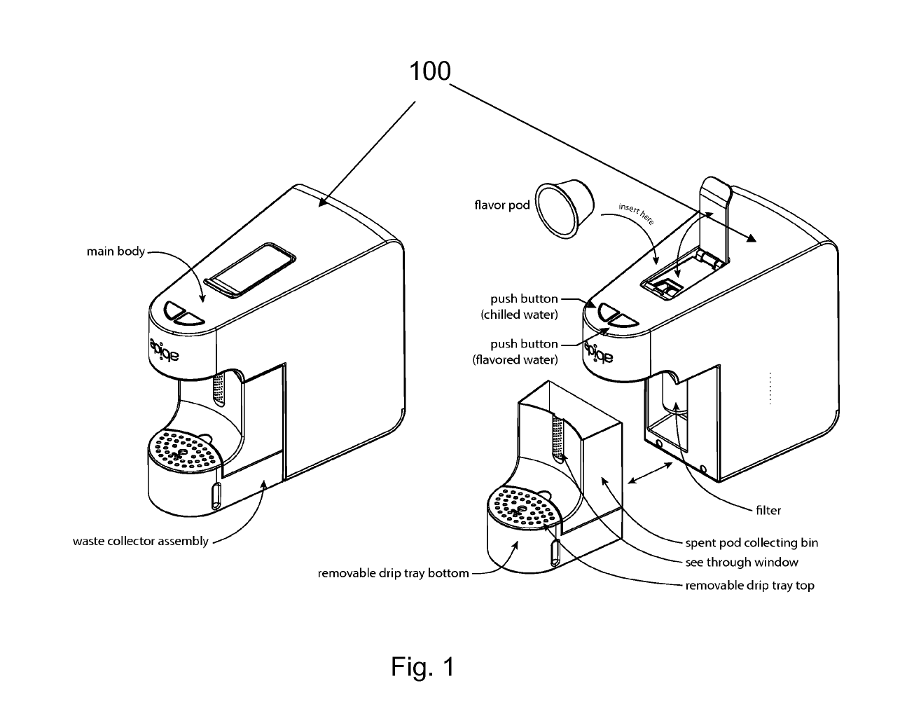

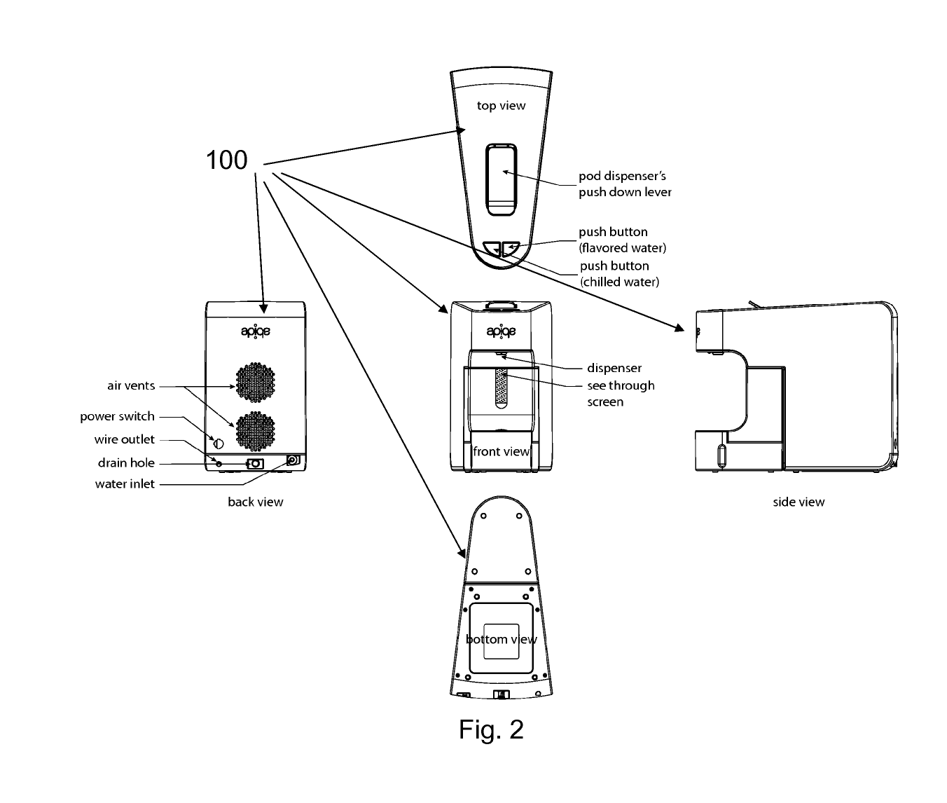

FIG. 1 shows an example of a dispenser 100 employing a single-serve pod system to dispense flavored beverages. As shown the dispenser 100 is a countertop unit providing filtered chilled water or a flavored beverage in response to a simple push button command by the user. However, it is to be understood that in various embodiments other suitable form factors and user interfaces may be used. FIG. 2 shows the dispenser 100 with respect to different view angles.

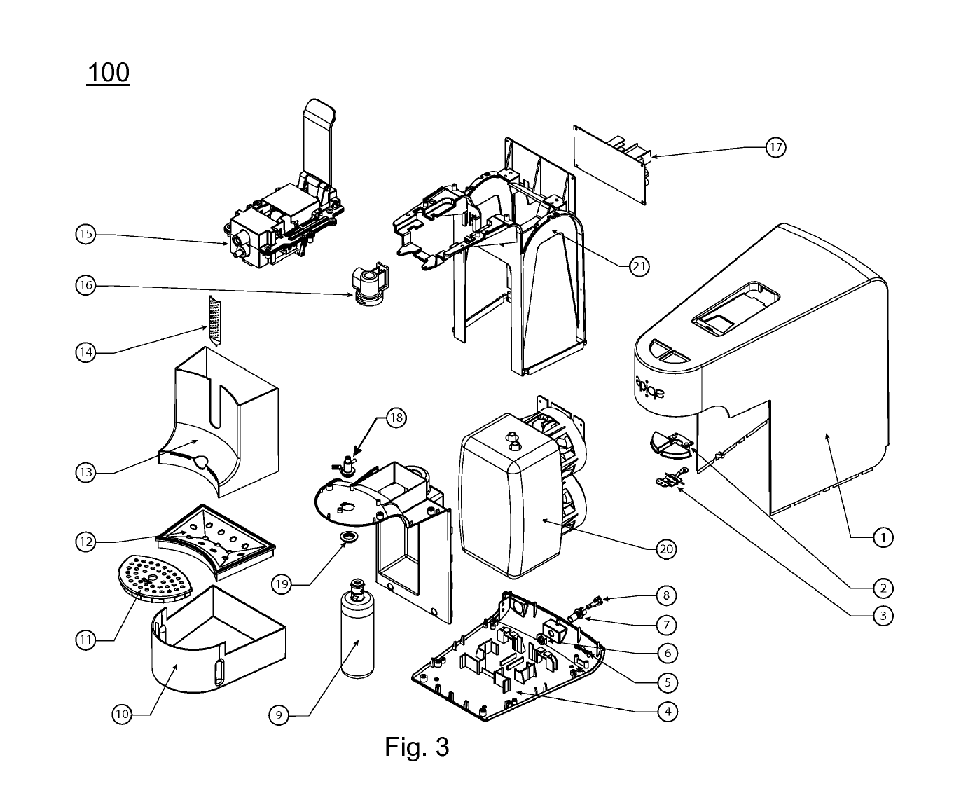

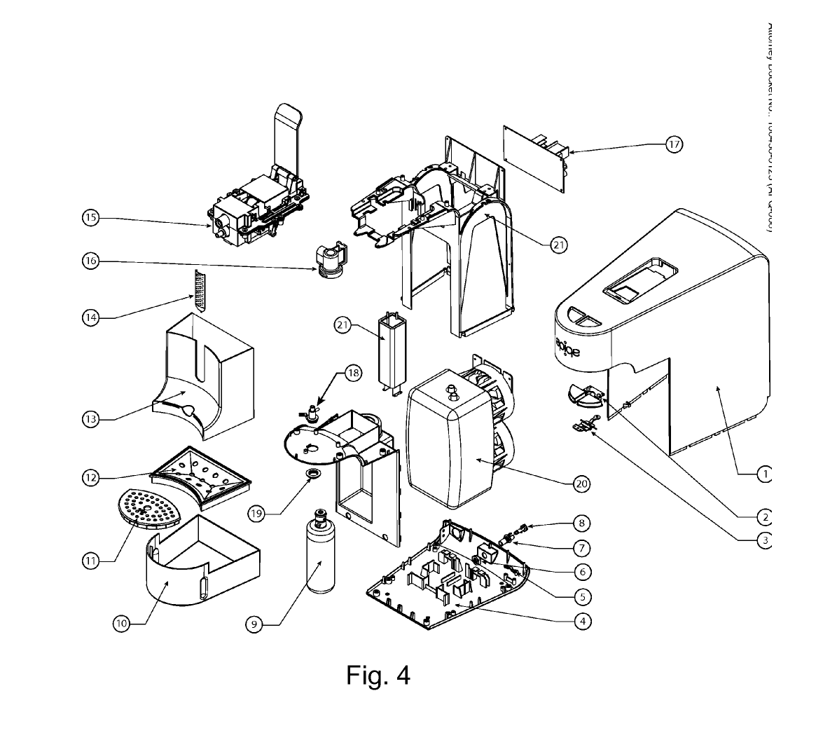

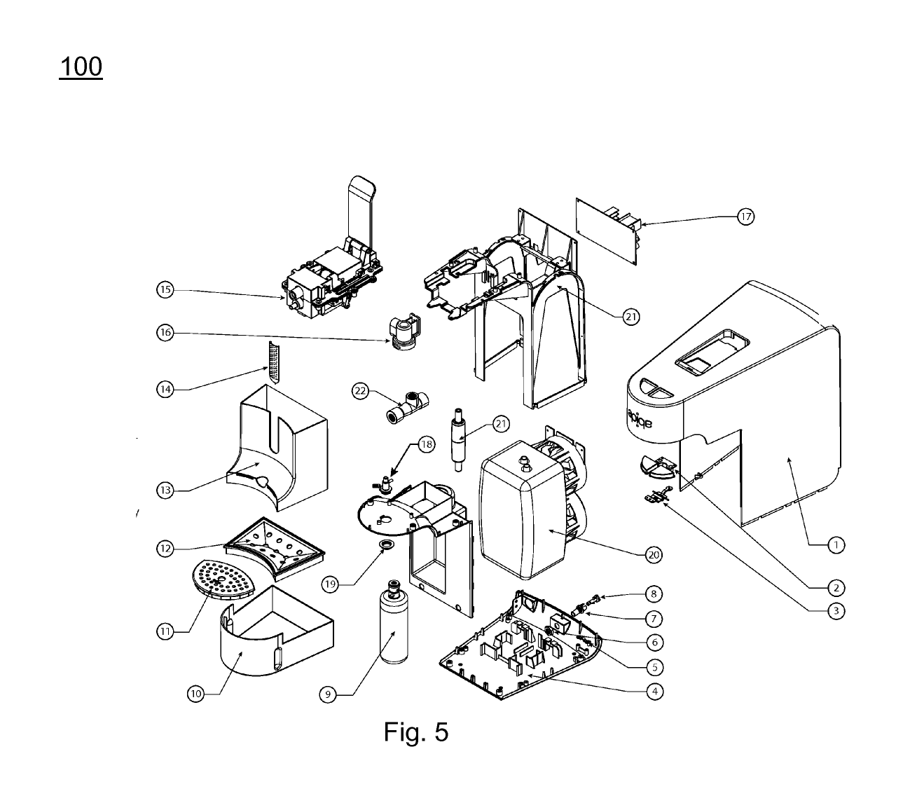

FIG. 3 shows an exploded view of the beverage dispenser of FIG. 1. FIG. 4 shows an exploded view of an alternate embodiment of the beverage dispenser of FIG. 1 additionally featuring hot beverage dispensing. FIG. 5 shows an exploded view of another alternate embodiment of the beverage dispenser of FIG. 1 additionally featuring hot and carbonated beverage dispensing.

In each of the dispensers shown in FIGS. 3-5, the dispenser 100 is contained in an appliance cabinet 1. The main functional components in the system are the filter 9 (e.g., of the type described in detail below), cooling system 20, flavor pod mechanism 15 (e.g., a single serve flavor pod dispenser of the type described in detail below), and the controller (e.g., implemented as a printed circuit board or PCB) 17. In various embodiments, the dispenser 100 may include any suitable control interface. As shown a push button 2 is used to actuate a switch mounted in a switch mount 3 to control dispensing.

The beverage may be dispensed into a cup other vessel through a dispensing nozzle unit 18, 19. The cup is positioned above a drip tray 10 with cover that allows spilled or dripped fluid to be collected. As shown this drip tray may also collect drips from used flavor pods collected in a waste bin 13 through a waste bin bottom 12. The used flavor pods may be ejected from the flavor pod dispenser 15, as detailed below. In some embodiments, the waste bin may include a see through screen 14 or other indicator that allows the user to recognize a full bin in need of emptying. The drip tray 10 may be in fluid communication with a drain system 6, 7, 8, for emptying (as shown mounted in base plate 4).

The dispenser 100 can include a main inlet configured to receive water from the main water source or a reservoir that can be filled. The main water valve directs the incoming water to the filter 9. The filtered water is then passed through the cooling system 20, e.g., a heat exchanger configured to chill water passing though a chilled water dispensing line. Some embodiments can include an unchilled water line including: an unchilled water inlet valve configured to selectively direct water from the main inlet to an unchilled water line outlet. In some embodiments, the unchilled water inlet valve is controlled by the controller 17.

In some embodiments, the chilled water dispensing line is configured to receive water at a temperature of about 20 C or greater, and dispense chilled water at a temperature of about 10 C or less. The cooling system can be any conventional cooling system either using a cooling tank or inline coolers using tubes in a cooled medium. In this apparatus, a thermoelectric (TE) cooling is used as the cooling system. The thermoelectric cooling system includes a water tank, TE elements, a heat sink for air (HSA), a heat sink for water (HSW), fans and fan cover. TE element uses Peltier effect principles to cool the drinking water. The Peltier effect is the conversion of electricity directly into temperature differences. When a current flows through the TE element, a rate of cooling −q occurs at the cold surface of the TE element and a rate of heating q occurs at the hot surface of the TE element. HSW will be cooled down by the cold surface of TE element, and it will further cool down the water in the tank. The heat from the hot surface is conducted to the HSA, which is cooled down by the fan.

In FIG. 5, the dispenser 100 is equipped with the inline carbonator 22 and an optional flow conditioner 23. In such cases, a carbonator water inlet valve configured to selectively direct water from the main inlet to the carbonator; a carbonator gas inlet valve configured to selectively direct carbonating gas to the carbonator; and a chilled water line outlet are present. In such embodiments, when the carbonator water inlet valve is open and the carbonator gas inlet valve is closed, the chilled water line dispenses still water at the chilled water line outlet. In some embodiments, when the carbonator water inlet valve is open and the carbonator gas inlet valve is open, the chilled water line dispenses carbonated water at the chilled water line outlet. Some embodiments include a carbonator gas source in fluid communication with the carbonator gas inlet valve. In some embodiments, the gas source includes a canister of pressurized carbon dioxide.

In some embodiments, the chilled water line includes a water pump configured to pump water to the carbonator. In some embodiments, carbonation can be achieved without the use of a water pump.

Some embodiments e.g., as shown in FIG. 4, include a hot water line including: a hot water inlet valve configured to selectively direct water from the main inlet to a hot water line outlet; a heater which heats water passing through the hot water line; and a hot water line outlet. Some such embodiments may include a hot tank 22 used to store hot water for use.

In some embodiments, substantially the entire apparatus is contained within an enclosure.

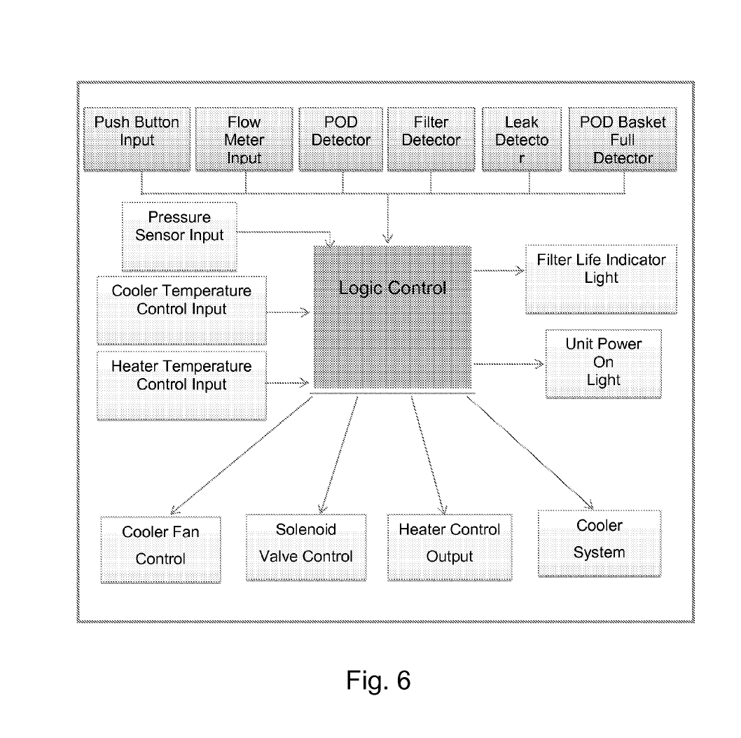

FIG. 6 shows an exemplary functional block diagram for the duspensor 100. The controller 17 is in functional communication with several input and output devices, sensors, and control modules. For example, in some embodiments, Some embodiments include: a cooling tank fill sensor in communication with the controller and configured to generate information indicative of a fill level of the cooling tank; and a cooling tank fill valve controlled by the controller and configured to selectively direct water from the main inlet to the cooling tank. In some embodiments, the controller is configured to control the operation of the cooling tank fill valve based on the information indicative of a fill level of the cooling tank. In some embodiments, such as in this case, a pressure switch is used to fill the cooling tank.

In various embodiments, the dispenser 100 may provide any of the functionalities described in International Patent Applications Ser. No. PCT/US2012/043873. PCT/US2012/043797, and PCT/US2012/043708 incorporated by reference above.

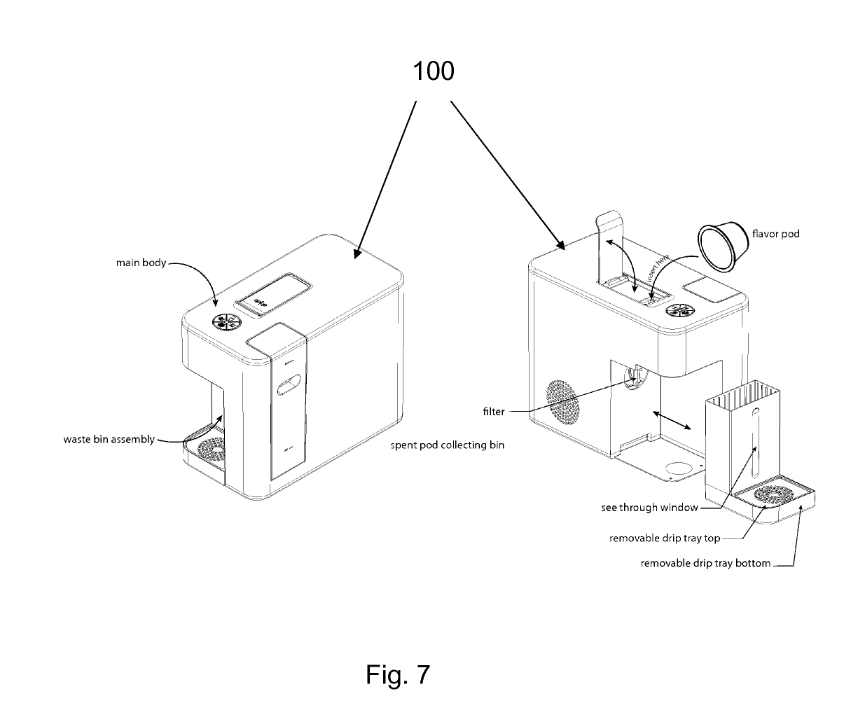

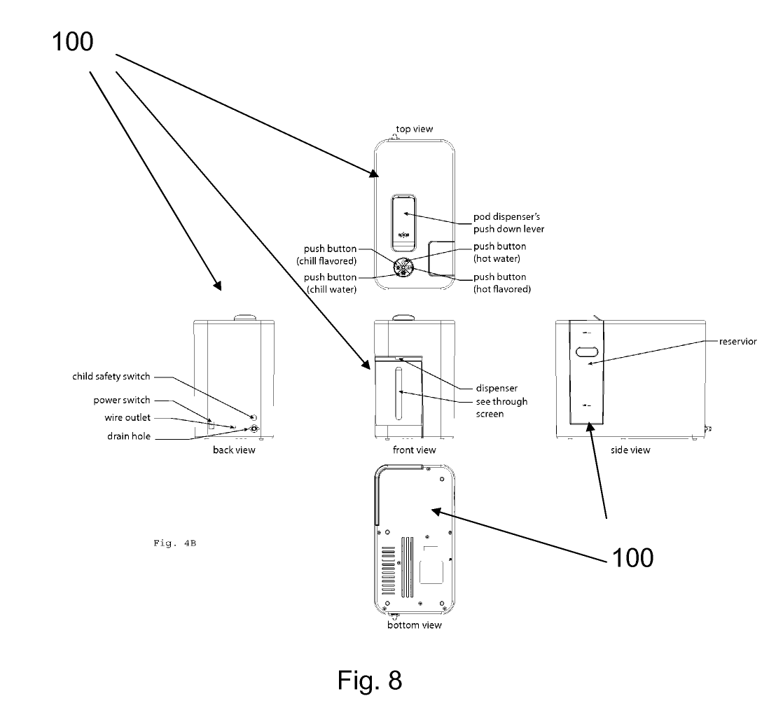

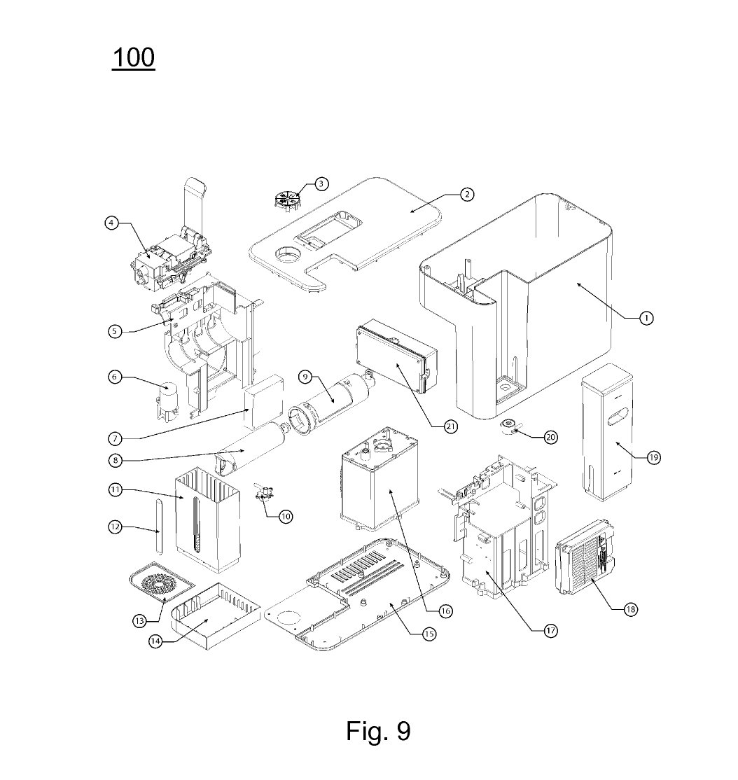

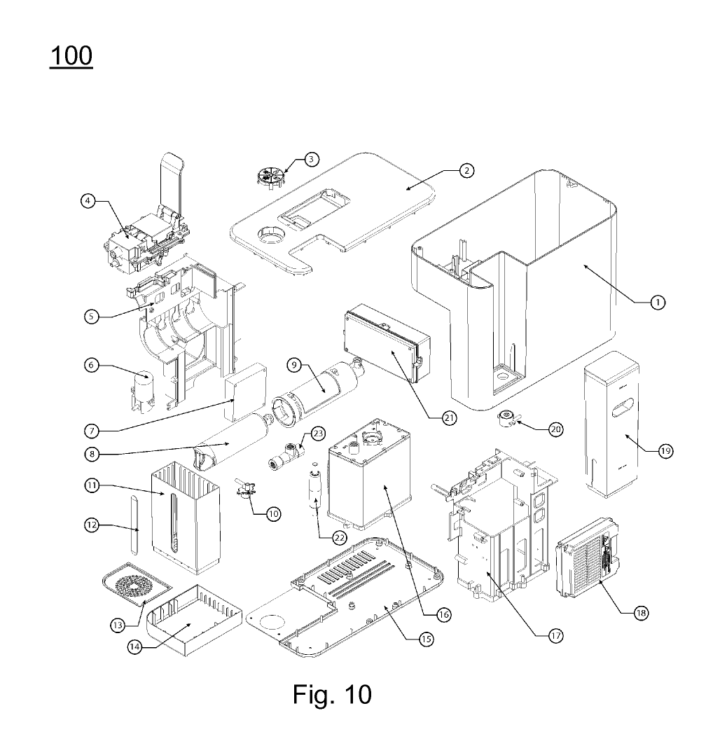

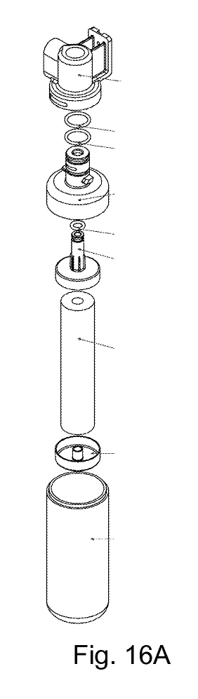

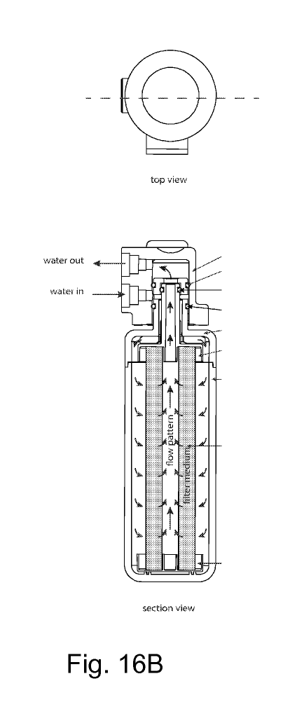

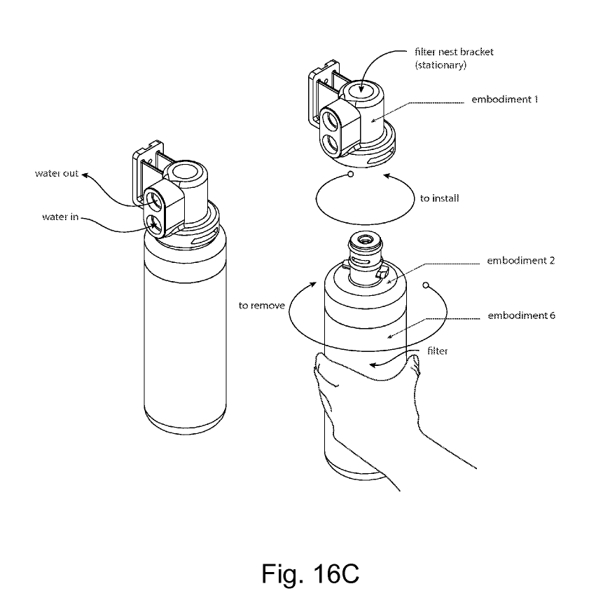

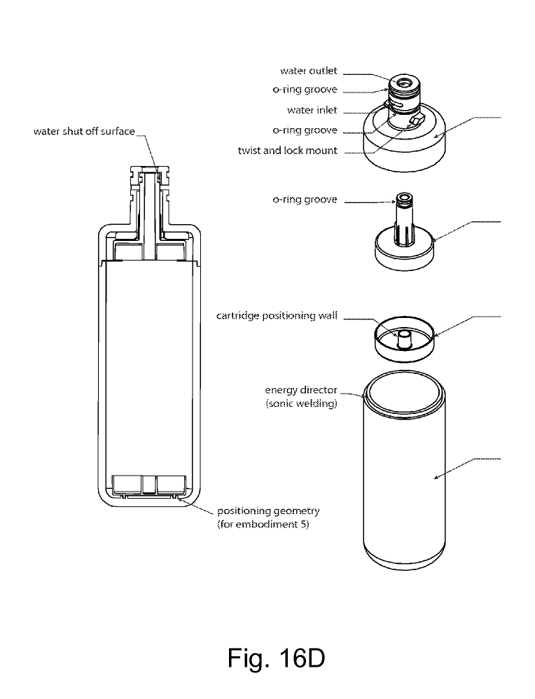

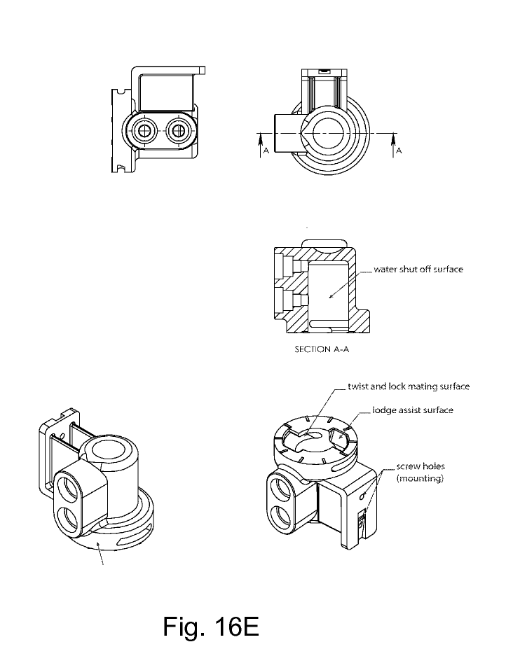

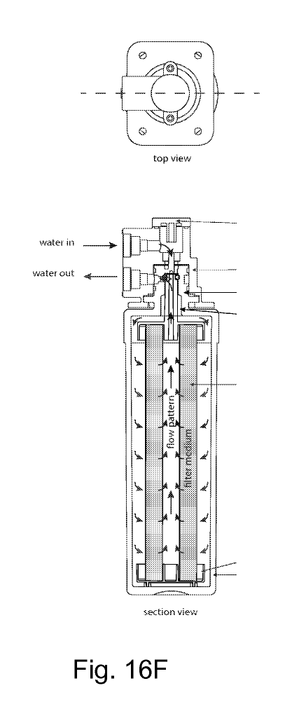

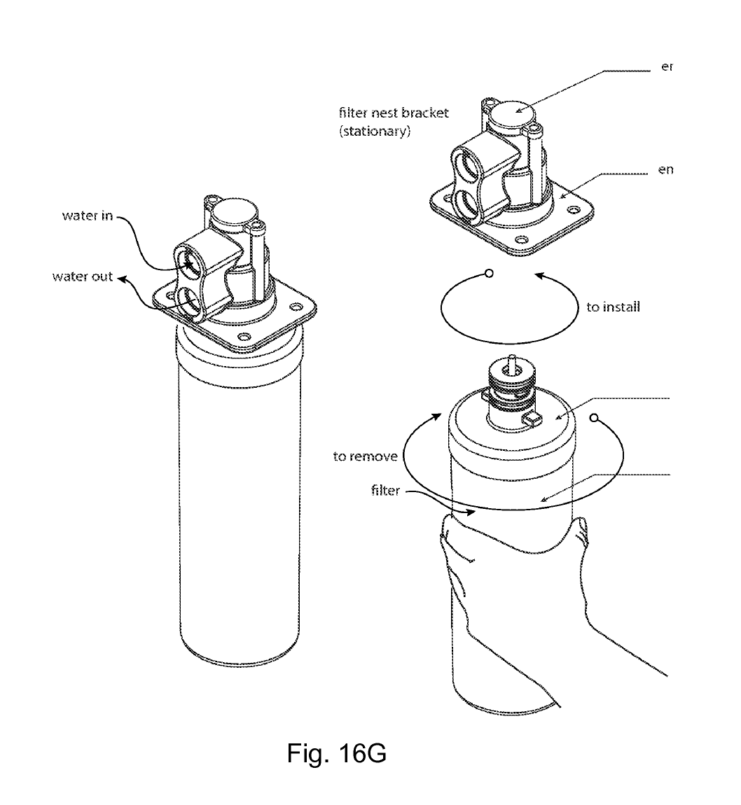

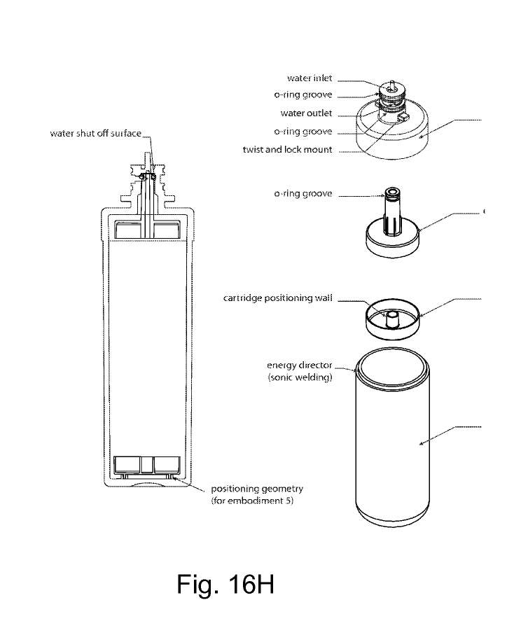

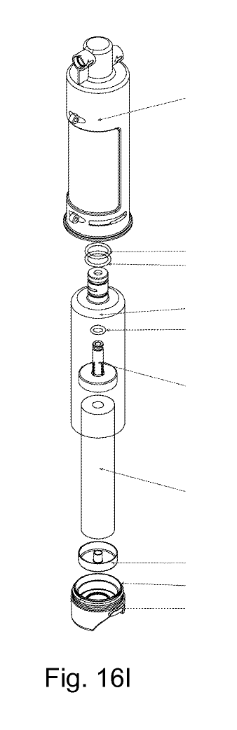

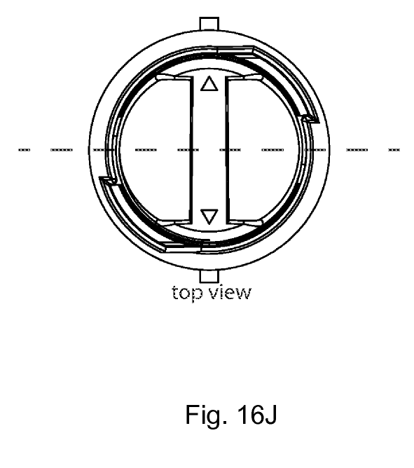

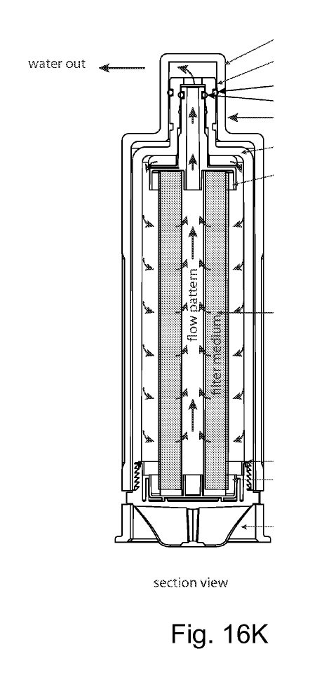

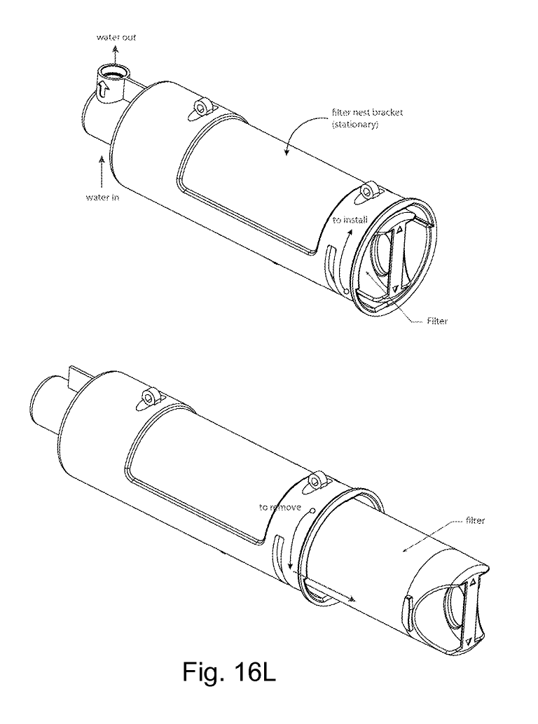

In various embodiments, the dispenser 100 may take any suitable form factor. FIGS. 7-10 illustrate alternate embodiments of the dispenser 100. In some embodiments, the form factor shown in FIGS. 7-10 may be advantageous in that the a side door is provided for convenient access for, e.g., changing of the filter. Furthermore the filter is mounted in a horizontal configuration within a nested bracket arrangement of the type shown in FIGS. 16I-16L below, again potentially increase easy filter changing.

As shown in the examples above, the dispenser 100 may include a single serve flavor pod dispensing mechanism 15. In general, this mechanism will receive a sealed flavor pod (or any other type of sealed container containing flavor material), unseal the pod, and facilitate mixing of the flavor material with water (e.g. chilled, unchilled, or hot still or sparkling water) flowing through the dispenser 100. The mechanism 15 then facilitates the disposal of the spent pod.

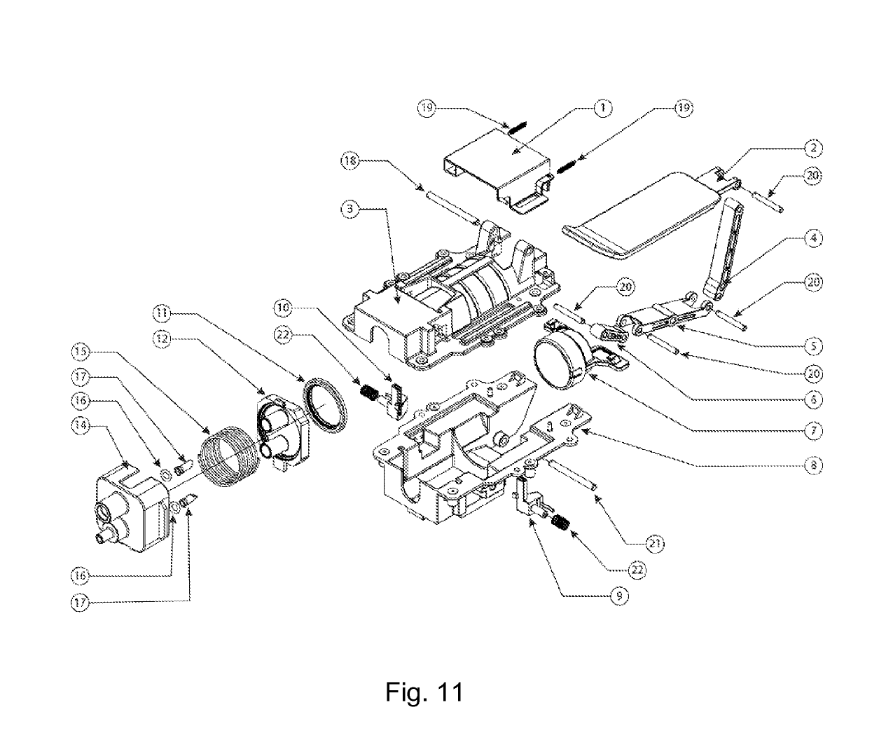

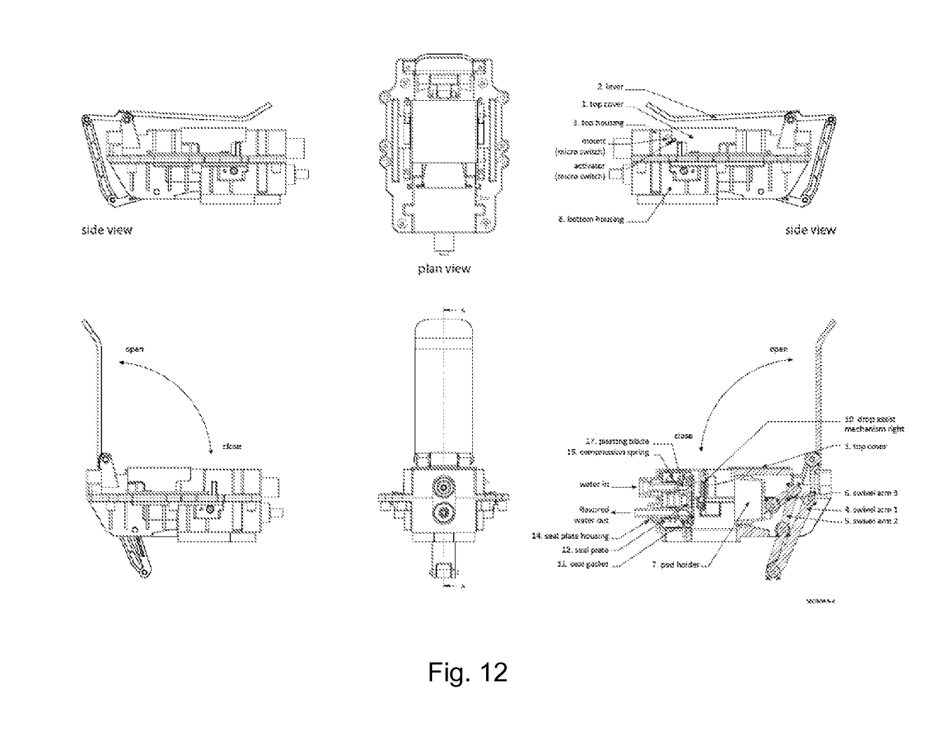

For example, referring to FIGS. 11-13, in some embodiments, the pod dispensing mechanism includes of three groups of elements: a pod delivery and retaining system, and flavor extraction system. The casing retains both the pod delivery system and the flavor extraction system in place and also serves as a primary support for mounting the pod dispensing mechanism as a whole onto the dispenser 100.

The primary objective of the pod delivery system is to position, retain, and dislodge spent pods. The secondary objective is to deliver the pod to the flavor extraction system, coordinate with the extraction system to extract flavor and mixing, and to serve as a mechanical locking mechanism against any back pressure created by the injection process of chilled water, hot water, and/or carbonated water into the pod. As shown, the dispensor is operated by user actuation of a lever, however, it is to be understood that in alternate embodiments, an automatically actuated system may be employed (e.g., using one or more servos or motors).

The flavor extraction system serves as a water shut-off from upon contact with the pod until the user releases the lever. The system comprises sub-system which creates incisions on the protective top cover on the pod to extract the flavor, synchronizes with the pod delivery system for lock out upon closing the whole system, and, coordinates with the delivery system in dislodging the spent pods.

As depicted, the casing includes a top cover 1, top housing 3, bottom housing 8 and tensioning element 19. In some embodiments, all the components are individually molded by plastics injection molding process to simplify the manufacturing process and reduce cost. They may be designed to be retrofitted on various dispenser models.

Top housing 3 retains top cover 1 in four degrees of freedom but the latter can move in forward and backward directions. Top housing 3 and bottom housing 8 serves as a clamshell-typed casing for the other two systems and is assembled together, e.g., with tapping screws. The two pieces of element 19 are connected to top cover 1 and top housing 3 together and are constantly pulling the element 1 towards the rear of the element 3 (e.g. using an elastic or spring force); while the end attached to top housing 3 is stationary. The intent of element 19 is to retract top cover 1 when the lever 2 is lifted up which will then allow the loading of a new flavor pod. When the lever 2 is pushed down with the intention to dispense flavor from the loaded flavor pod, top cover 1, driven by the motion of the lever 2 through swivel arm elements 4, 5, 6, will then travel towards the flavor extraction system together with swivel arm 6, and actuate an electronics micro switch to close.

The electronics micro switch is mounted onto the top housing 3 and serves a bridge which controls the open and close position of an electrical circuit. When the lever 2 is pushed down, it will make the top cover 1 to move forward which then closes the electronic circuit which, e.g., supplies, e.g., DC power to the push button for flavor dispensing. When the lever 2 is lifted up, the top cover 1 will move away from the flavor extraction system which then opens up the electronic circuit. This will cut off the electricity from the power source to the push button for flavor dispensing.

Various embodiments may employ any other suitable sensors for detection of the open/close position of the level and may use this sensor output to control the operation of the dispenser 100 in any suitable fashion.

The pod delivery and retaining system includes lever 2, pod holder 7, swivel arms 4, 5, 6, and swivel hinges 18, 20, 21. The lever 2 serves as leverage arm which allows the opening of the whole pod dispensing system, and lock down of the flavor extraction system when the system is in use. In some embodiments, due to the system requirements of mechanical strength and fatigue, the element 2 may be manufactured of a sturdy material, e.g., by using die casting techniques with metallic alloy.

The swivel hinges 20 serve as a hinge in between the lever 2 and the swivel arm 4, between swivel arms 4 and 5, and between swivel arm 5 and 6. In some embodiments, each hinge 20 has a pan head at one end to prevent it from dislodging and the other end which has a clearance hole perpendicular to the body will allow and house a “R” shape retaining clip made of metal to complete the clasping. The hinges 20 may be made of a sturdy material such as stainless steel to sustain high mechanical torque, and stress. In some embodiments, swivel arms 4, 5, and 6 are molded by plastics injection molding process. The combination of swivel elements 4, 5, and 6 (1) drives the pod delivery, retaining, and dislodging of flavor pod, and (2) provides the necessary force to create water shut-off in between the pod delivery system and the flavor extraction system.

In some embodiments, each individual component coordinates and participates in (1) pushing the pod holder 7 towards the flavor extracting system when the lever 2 is pushed down to load a new flavor pod, and pulling the pod holder 7 away from the flavor extracting system when the lever 2 is pulled up to dislodge the spent pod.

Swivel arm 4 creates a mechanical link in between lever 2 and swivel arm 5, whereas the center of swivel arm 5 anchors onto bottom housing 8 and serves as an agent, which transfers rotational displacement to translational displacement and vice versa in between swivel arms 4 and 6. Accordingly, rotational motion of the lever 2 way be converted to linear motion for translating elements of the dispenser, such as the top cover 1, pod holder 7, and seal plate 12 (discussed below).

The pod holder 7 operates to transfer a new flavor pod from pod catching elements 9 and 10 (which operate to catch and hold a pod inserted into the mechanism) and deliver it to the flavor extraction system. The pod holder 7 also acts as a water shut-off, and drives top cover 1 in actuating and deactivating of the electronics switch described above. In some embodiments, the pod holder 7 is manufactured by using plastics injection molding technique to simplify the manufacturing process.

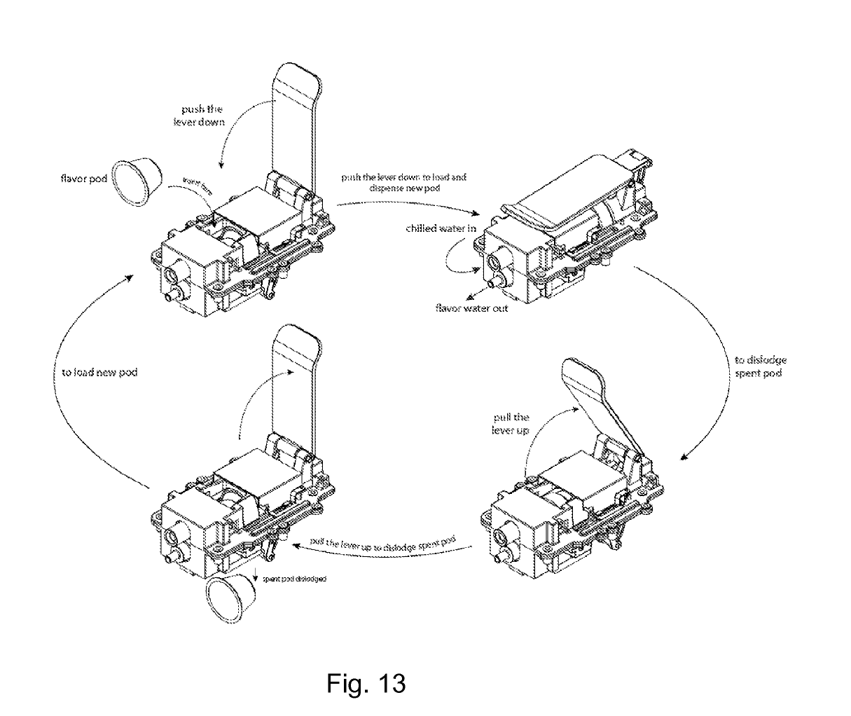

When the dispensing process begins, pod holder 7 travels forward and embraces a new flavor pod. Subsequent shift in the pod delivery system will force element 7 to push both catching elements 9 and 10 to move laterally away from the pod holder 7. This releases the new flavor pod from catching element 9 and 10. The new pod is then embraced and carried toward the flavor extraction system by the pod holder 7. During this time, both catching elements 9 and 10 are being prevented from retracting to their equilibrium position. When pod holder 7 retracts away from the flavor extraction system (during dislodging stage), it then restores both elements 9 and 10 to their un-retracted equilibrium positions. In some embodiments, two tapered channels on the sides of pod holder 7 serve as runways for the catching elements 9 and 10 to wedge out the spent pod. The working principle of the pod dispensing mechanism is illustrated in FIG. 13.

There are two objectives of pod catching elements 9 and 10 in conjunction with spring elements 22. The first objective is to position and retain a new flavor pod upon loading. The next objective is to dislodge the spent pod from the whole system. In some embodiment, both catching element 9 and 10 are manufactured by plastics injection molding techniques.

In some embodiments, both elements 9 and 10 have rectangular slot running length-wise. The slots are open at the top which receives and retains the pod rim sideways, the bottom part, however, is closed and prevents the loaded pod from dislodging from the system. Both element 9 and 10 are fastened onto bottom housing 8 by tapping screws from the exterior part of element 8. Spring elements 22 are inserted in between catching element 9 and bottom housing 8, and in between catching element 10 and bottom housing element 8 during the installation. In an equilibrium position, each spring element 22 pushes a respective one of catching elements 9 and element 10 towards the center of the pod dispensing mechanism.

When the pod delivery system is in loading process, due to the lateral action force exerted by pod holder 7 onto catching elements 9 and 10, spring elements 22 retract away from the center of the pod dispensing mechanism, and consequently, the lateral shift allows the flavor pod to transfer from the restraint of elements 9 and 10 onto the pod holder 7. During dislodging stage, the rectangular remnant located on the side of element 9 and 10, slots into the runways of pod holder 7. This process stops the spent pod from moving any further with pod holder 7 and subsequently expels the spent pod from the pod dispensing mechanism. For example, in some embodiments the spent pod may drop through an opening into a disposal bin in the dispenser 100.

The flavor extraction system includes seal a seal gasket 11, seal plate 12, seal housing 14, compression spring 15, blade seals 16, and piercing blades 17. In some embodiments, the seal gasket 11 is co-molded with element 12 to simplify the assembly procedure and create stronger bond for durability. In some embodiments, one half of the seal gasket 11 is molded inside element 12 and the other half serves as a conical washer. It has a slightly cupped shape that provides spring-like flexibility to resist the flavor pod from sticking onto the flavor extraction system. It also prevents the spent pod from catching onto piercing blades 17 and assists in ejection of the spent pod.

Seal plate 12 may move along two degrees of freedom: forward and backward along the length of the dispenser. The other four degree of freedom, however, are constrained by the elements 3, 8, and 14. Plate 12 includes of two cylindrical hollow stems running width-wise. The inside surfaces of the hollow stems acts as water shut-off surfaces in conjunction with the blade seals 16. The blade seals 16 may be made of rubber, co-molded with element 12 by injection molding technique. Each of the blade seals 16 envelops approximately half the length of the inside surfaces of the hollow stems on seal plat 12.

During the first stage of the flavor extraction process, seal plate 12, together with seal gasket 11, is pushed backward by the pod delivery system. This process exposes and introduces the piercing blades 17 to the flavor pod. The sharp edges of blades 17 then pierce through the pod, e.g., through a protective screen of the flavor pod.

In the second stage of the flavor extraction process, chilled water is then injected inside the flavor pod through the seal housing 14. During this process, excess water, if any, flows inside the hollow stems of seal plate 12 12. The excess water cannot advance further out of element 12 due to the sealant created by the interference between blade seals 16 and the inside cylindrical surfaces of seal plate 12. To assist seal plate 12 in moving forward and backward which creates water shut-off in between the seal gasket 11 and the pod holder 7, and to eject the spent pod from the blades 17, compression spring 15 is installed inside and in between the seal plate 12 and the seal housing 14.

In some embodiments, the compression spring 15 is made of stainless steel for better corrosion resistance and durability. In some embodiments, the spring constant of compression spring 15 is approximately 16 lbs/inch, e.g., in the range of 10-20 lbs/inch.

In some embodiments, the piercing blades 17 are each made of stainless steel and co-molded with seal housing 14. In some embodiments, one end of the blade 17 is machined out to create a blade-shaped edge, e.g., at about 45 degree angle, and this edge is used to puncture the protective screen on the flavor pod. The other end of element 17 is flared out to approximately 1.5 times the diameter of the tube. And the flared end provides a strong bond and water-proof sealant when co-molded with seal housing 14.

In some embodiments, the seal housing 14 is manufactured by using plastics injection molding techniques. In some embodiments one side has a rectangular cupped shape which houses elements 12, 15, and 17. The opposite side may have a tube shape geometry and a stem. The tube shape geometry may be routed to the water inlet whereas the stem may be connected directly to the dispensing nozzle.

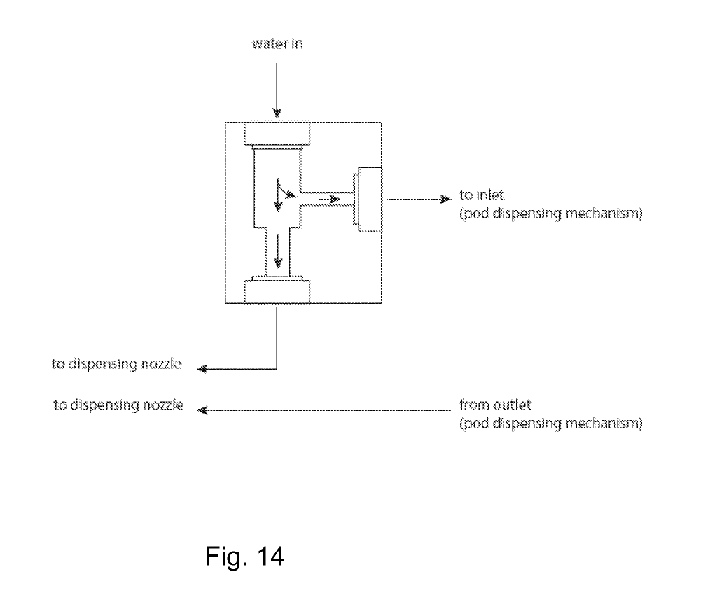

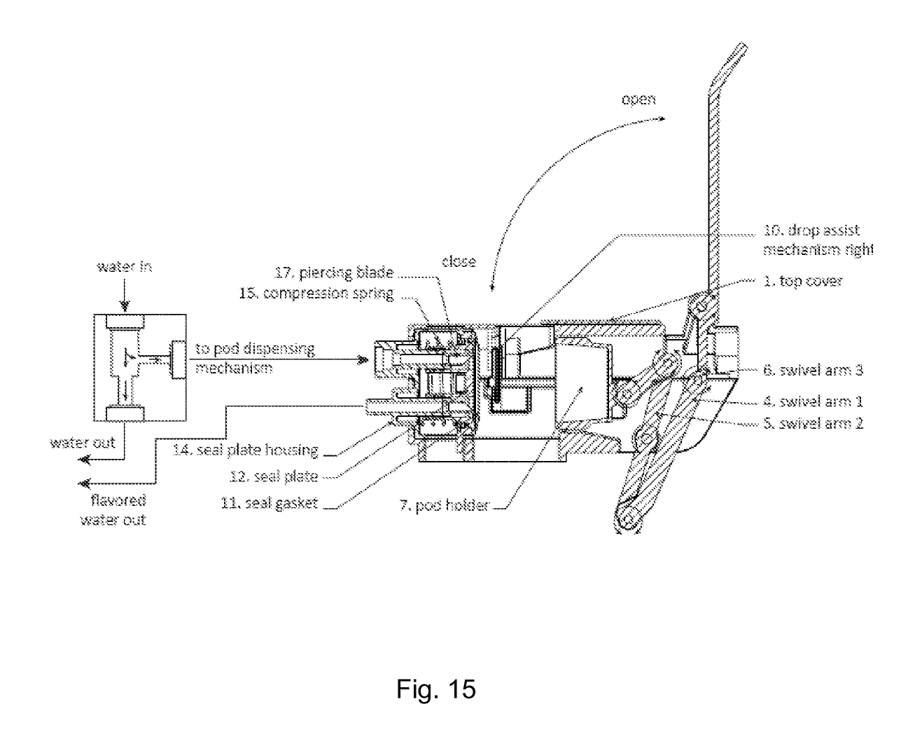

Referring to FIGS. 14 and 15, in some embodiments (e.g., those featuring the use of carbonated water), it may be desirable to divert only a portion of the flow from a water line (e.g., a carbonated water line) through the flavor pod, e.g., using a flow splitting mechanism as shown. The resulting flavored water stream from the pod can then be returned to the main stream of, where the streams mix to form a flavored beverage.

As described above, dispenser 100 may include one or more water filters. FIGS. 16A-L illustrate an various exemplary filter cartridges for use with such dispenser systems. FIGS. 16A-16E show views of a first embodiment. FIGS. 16F-16H show views of a second embodiment. FIGS. 16 I-16L show views of a third embodiment featuring a nested bracket arrangement.

In general, each type of cartridge includes an inlet for unfiltered water, an outlet for filtered water. The cartridge contains a filter media. In some embodiments, the cartridge is constructed such that the filter media may not be replaced without damaging the cartridge. In other embodiments, the media may be replicable. Some embodiments feature a flow pattern as illustrated. In some embodiments, the filter cartridge may be attached using a twist to lock mechanism. In general the filter cartridge may include any of the features described in the applications incorporated by reference above, including Patent Applications Ser. No. PCT/US2012/043873. PCT/US2012/043797, and PCT/US2012/043708 incorporated by reference above.

The components described above may be made of any suitable material. In some embodiments, one or more of the components are formed from or include a plastic (e.g., a thermoplastic) or polymer material (e.g., PFTE, PV, PU, nylon, etc.), a metal (e.g., copper, bronze, iron, steel, stainless steel, etc.), a composite, etc. The components may be fabricated using any suitable technique including, e.g., molding (e.g., injection molding), machining (e.g., using one or more computer numerical controlled “CNC” tools such as a mill or lathe), etc.

Any suitable connection may be used to provide fluid communication between various components. The connections may be permanent (e.g., glued) or detachable (e.g., using threaded connections). Any threaded connections may be national pipe thread tapered thread (NPT) or national pipe thread tapered thread fuel (NPTF) standard connections. In some embodiments, the threaded connections provide leak proof fittings mechanically, without the need for Teflon thread tape or similar applications.

The examples described above are presented with reference to providing a dispenser for a flow of carbonated water. However, as will be understood by one skilled in the art, the devices and techniques described herein may be applied to dispensing any suitable fluid flow, including any suitable mixed flow of liquid and gas.

Although the examples provided above show countertop beverage dispenser, a person skilled in the art will recognize the any of the devices described herein may be adapted for other uses, e.g., under-counter systems, systems integrated into major appliances (e.g., refrigerators), point of sale devices, etc.

The above-described systems and methods (including functions of the control board shown above) can be implemented in digital electronic circuitry, in computer hardware, firmware, and/or software. The implementation can be as a computer program product (i.e., a computer program tangibly embodied in an information carrier). The implementation can, for example, be in a machine-readable storage device, for execution by, or to control the operation of, data processing apparatus. The implementation can, for example, be a programmable processor, a computer, and/or multiple computers.

A computer program can be written in any form of programming language, including compiled and/or interpreted languages, and the computer program can be deployed in any form, including as a stand-alone program or as a subroutine, element, and/or other unit suitable for use in a computing environment. A computer program can be deployed to be executed on one computer or on multiple computers at one site.

Method steps can be performed by one or more programmable processors executing a computer program to perform functions of the invention by operating on input data and generating output. Method steps can also be performed by and an apparatus can be implemented as special purpose logic circuitry. The circuitry can, for example, be a FPGA (field programmable gate array) and/or an ASIC (application specific integrated circuit). Modules, subroutines, and software agents can refer to portions of the computer program, the processor, the special circuitry, software, and/or hardware that implements that functionality.

Processors suitable for the execution of a computer program include, by way of example, both general and special purpose microprocessors, and any one or more processors of any kind of digital computer. Generally, a processor receives instructions and data from a read-only memory or a random access memory or both. The essential elements of a computer are a processor for executing instructions and one or more memory devices for storing instructions and data. Generally, a computer can include, can be operatively coupled to receive data from and/or transfer data to one or more mass storage devices for storing data (e.g., magnetic, magneto-optical disks, optical disks, or solid state devices/memories).

Data transmission and instructions can also occur over a communications network. Information carriers suitable for embodying computer program instructions and data include all forms of non-volatile memory, including by way of example semiconductor memory devices. The information carriers can, for example, be EPROM, EEPROM, flash memory devices, magnetic disks, internal hard disks, removable disks, magneto-optical disks, CD-ROM, and/or DVD-ROM disks. The processor and the memory can be supplemented by, and/or incorporated in special purpose logic circuitry.

To provide for interaction with a viewer, the above described techniques can be implemented on a computer having a display device. The display device can, for example, be a cathode ray tube (CRT) and/or a liquid crystal display (LCD) monitor. The interaction with a viewer can, for example, be a display of information to the viewer and a keyboard and a pointing device (e.g., a mouse or a trackball) by which the viewer can provide input to the computer (e.g., interact with a viewer interface element). Other kinds of devices can be used to provide for interaction with a viewer. Other devices can, for example, be feedback provided to the viewer in any form of sensory feedback (e.g., visual feedback, auditory feedback, or tactile feedback). Input from the viewer can, for example, be received in any form, including acoustic, speech, and/or tactile input.

The above described techniques can be implemented in a distributed computing system that includes a back-end component. The back-end component can, for example, be a data server, a middleware component, and/or an application server. The above described techniques can be implemented in a distributing computing system that includes a front-end component. The front-end component can, for example, be a client computer having a graphical viewer interface, a Web browser through which a viewer can interact with an example implementation, and/or other graphical viewer interfaces for a transmitting device. The components of the system can be interconnected by any form or medium of digital data communication (e.g., a communication network). Examples of communication networks include a local area network (LAN), a wide area network (WAN), a personal area network (PAM), the Internet, wired networks, and/or wireless networks.

The system can include clients and servers. A client and a server are generally remote from each other and typically interact through a communication network. The relationship of client and server arises by virtue of computer programs running on the respective computers and having a client-server relationship to each other.

The communication network can include, for example, a packet-based network and/or a circuit-based network. Packet-based networks can include, for example, the Internet, a carrier internet protocol (IP) network (e.g., local area network (LAN), wide area network (WAN), campus area network (CAN), metropolitan area network (MAN), home area network (HAN)), a private IP network, an IP private branch exchange (IPBX), a wireless network (e.g., radio access network (RAN), 802.11 network, 802.16 network, general packet radio service (GPRS) network, HiperLAN), and/or other packet-based networks. Circuit-based networks can include, for example, the public switched telephone network (PSTN), a private branch exchange (PBX), a wireless network (e.g., Zigbee, bluetooth, time division multiple access (TDMA) network, global system for mobile communications (GSM) network), and/or other circuit-based networks.

The communication device can include, for example, a computer, a computer with a browser device, a telephone, an IP phone, a mobile device (e.g., cellular phone, personal digital assistant (PDA) device, laptop computer, electronic mail device), and/or other type of communication device. The browser device includes, for example, a computer (e.g., desktop computer, laptop computer) with a world wide web browser (e.g., Microsoft® Internet Explorer® available from Microsoft Corporation, Mozilla® Firefox available from Mozilla Corporation). The mobile computing device includes, for example, a personal digital assistant (PDA).

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations.

However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.).

It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

The foregoing description of illustrative embodiments has been presented for purposes of illustration and of description. It is not intended to be exhaustive or limiting with respect to the precise form disclosed, and modifications and variations are possible in light of the above teachings or may be acquired from practice of the disclosed embodiments. It is intended that the scope of the invention be defined by the claims appended hereto and their equivalents.

What is claimed is:

1. An apparatus for mechanically dispensing flavor from a flavor pod, the apparatus comprising:
a casing;
a pod delivery and retaining unit, and
a flavor extraction unit.

2. The apparatus of claim 1, wherein the pod delivery and retaining unit is configured to position and retain a pod inserted in the apparatus, and dislodge spent pods following flavor extraction.

3. The apparatus of any preceding claim wherein the pod delivery and retaining unit to is configured to:
deliver the pod to the flavor extraction unit,
coordinate with the extraction system to extract flavor and mixing, and
serve as a mechanical locking mechanism against back pressure created by the injection fluid into the pod.

5. The apparatus of any preceding claim, wherein the apparatus is lever actuated.

6. The apparatus of any preceding claim, wherein the flavor extraction unit selectively serves as a water shut-off.

7. The apparatus of any preceding claim wherein the flavor extraction unit is configured to create incisions in the pod to extract the flavor.

8. The apparatus of any preceding claim, wherein the casing comprise:
a top cover,
a housing; and
tensioning element;
wherein the housing retains the top cover while allowing the top cover to slidably open to expose the interior of the housing; and
wherein the tensioning element provides a force tending to slide the top cover towards an open position.

9. The apparatus of claim 8, further comprising a lever mechanism configured to actuate the top cover between an the open position and a closed position.

10. The apparatus of claim 8 or claim 9, comprising at least one sensor configured to detect an open or closed position of the top cover housing.

11. The apparatus of any preceding claim wherein the pod delivery and retaining unit comprises:
a lever configured to allow the opening and closing of the top cover, and sealed lock down of the flavor extraction unit during extraction.

12. The apparatus of claim 11, further comprising a pod holder actuated by movement of the lever.

13. The apparatus of claim 12, further comprising one or more swivel arms configured to convert rotational motion of the lever into lateral motion of the pod holder.

14. The apparatus of claim 12 or claim 13, configured such that the pod holder is pushed towards the flavor extracting system when the lever is pushed down to load a new flavor pod, and the pod holder is pulled away from away from the flavor extracting system when the lever is pulled up to dislodge pod.

15. The apparatus of any one of claims 12-14, further comprising one or more pod catching elements configured to receive a pod inserted through the housing and transfer the pod to the pod holder in response to actuation of the lever.

16. The apparatus of claim 15, wherein, in response to actuation of the lever: the pod holder travels towards and receives a flavor pod; and
the pod holder laterally displaces the catching element to release the pod into the pod holder.

17. The apparatus of claim 16, wherein the catching element comprises a spring element having an equilibrium position, and the pod holder is configured to displace the catching element away from the equilibrium position.

18. The apparatus of claim 16 or claim 17, wherein, during an unloading actuation of the lever, the catching elements are configure to facilitate disposal of a pod from the apparatus.

19. The apparatus of any one of claims 12-18, wherein he flavor extraction system includes:
a seal plate,
a seal housing opposing the seal plate,
wherein the seal housing and seal plate are configured to, in response to actuation of the lever:
receive the pod;
pierce the pod: and
establish a sealed fluid flow path through the pod to promote mixing of flavor material in the pod with fluid flowing through the path.

20. The apparatus of any preceding claim further comprising a flow splitting mechanism configured:
divert a portion of the flow from a fluid line to the flavor pod; and
return a resulting flavored water stream from the pod to be mixed with a main stream of the water line.

21. A method comprising:
dispensing flavor using the apparatus of any one of claims 1-20.

22. An system for dispensing flavored water comprising:
a main inlet configured to receive water from a source;
a filter for filtering water from the source;
a flavor dispenser comprising the apparatus of any one of claims 1-20;
a controller configured to control the flow of fluid through the system to selectively dispense flavored and unflavored water.

23. The system of claim 22, comprising:
a chilled water line, comprising:
an in-line carbonator;
a carbonator water inlet valve configured to selectively direct water from the main inlet to the carbonator;
a carbonator gas inlet valve configured to selectively direct carbonating gas to the carbonator; and
a chilled water line outlet configured to direct chilled water to the flavor dispenser;
a heat exchanger configured to chill water passing through the chilled water dispensing line; and
a controller configured to control the carbonator water and gas inlet valves, wherein:
when the carbonator water inlet valve is open and the carbonator water inlet valve is closed, the chilled water line dispenses still water at the chilled water line outlet; and
when the carbonator water inlet valve is open and the carbonator water inlet valve is open, the chilled water line dispenses carbonated water at the chilled water line outlet.

24. The apparatus of claim 22 or claim 23, comprising:
an unchilled water line comprising:
an unchilled water inlet valve configured to selectively direct water from the main inlet to an unchilled water line outlet, the outlet configured to direct chilled water to the flavor dispenser.

25. The apparatus of any one of claims 22-24, comprising:
an unchilled water line comprising:
an unchilled water inlet valve configured to selectively direct water from the main inlet through a heater to a heated water line outlet, the outlet configured to direct heated water to the flavor dispenser.
